(19) United States
(12) Patent Application Publication
(10) Pub. No.: US 2010/0139485 A1
(43) Pub. Date: Jun. 10, 2010

(54) GAS RECOVERY PROCESS

(76) Inventors: Alberto I. Lacava, Bethlehem, PA (US); Frank R. Fitch, Bedminster, NJ (US); Arthur I. Shirley, Hillsborough, NJ (US)

Correspondence Address: The BOC Group, Inc., 575 MOUNTAIN AVENUE, MURRAY HILL, NJ, 07974-2082, US

(21) Appl. No.: 12/515,065

(22) PCT Filed: Jul. 3, 2008
(86) PCT No.: PCT/US2007/088078

§ 371 Date: Feb. 11, 2010

Related U.S. Application Data
(60) Provisional application No. 60/876,067, filed on Dec. 20, 2006.

(51) Int. Cl. B01D 53/047; B01D 53/02

(52) U.S. Cl. 95/103; 95/96

(57) ABSTRACT

A method for concentrating a single gas component from a gas mixture is disclosed. The method utilizes concentration units and recovery units to concentrate the single gas component which is often at very low concentrations in the gas mixture. This method allows for the recovery of a valuable gas depending upon application such as oxygen and Ar-40.

### BACKGROUND OF THE INVENTION

This application claims priority from International Application Serial No. PCT/US2007/088078 filed 19 Dec. 2007 (published as WO 2008/079858 A1, with publication date 3 Jul. 2008), which claims priority from U.S. Provisional Patent Application Ser. No. 60/876,067, filed Dec. 20, 2006.

Simple 1, 2 or 3-bed pressure swing adsorption or vacuum swing adsorption separation units (PSAs and VSAs, respectively) utilizing relatively simple cycles are widely utilized for bulk separations of gases where moderate quantities, moderate yields and moderate purities of, e.g., nitrogen or oxygen from air are required. H₂ is commercially purified to >99% purity using PSA units that comprise many beds (e.g., 6 to 12) and that use more complex cycles with multiple equalizations. H₂ recovery levels of 80 to 90% can be realized in this way.

In general, feed gas compositions containing at least 10 to 20% concentration of the desired product, preferably more, are required in order to obtain moderate recoveries (>50 to 80%) and moderate purities (>90%) of the desired product.

In a few commercial applications a second PSA/VSA plant is utilized to obtain a second gaseous product from the waste stream of a first PSA plant, for example in a case where a concentrated CO stream is desired, in addition to the standard H₂ product obtained from an SMR plant using a single stage (multi-bed) H₂ PSA plant.

PSA/VSA is generally not thought to be a viable technology for the concentration to high purity of a desired gaseous product from a very dilute feed stream, let alone for achieving this aim at high recovery. Cryogenic distillation can give very high purity products dependent of the equilibrium vapor pressure data for the components to be separated, but in the case of a very dilute feed gas stream this will require the energy intensive liquefaction of the whole feed stream. What is needed is a PSA/VSA system that can cost effectively recover a valuable product from a dilute feed gas stream at high concentration and recovery.

### SUMMARY OF THE INVENTION

The present invention provides for methods for recovering a dilute gas component from a gas mixture at higher concentration and higher recovery (yield).

For purposes of the present invention, higher concentrations are about 70 to about 100% and higher recoveries are about 80 to 99% In preferred embodiments, higher concentrations are about 90 to 99.9%, most preferably from 90 to 99% and higher recoveries are about 85 to 97%, most preferably 85 to 95%. Low concentrations are about 0.1 to 10%, although lower concentrations (in the parts per million) can be processed with the methods of this invention.

The methods of the present invention will allow for both the recovery of a dilute gas component of relative high value in higher concentrations but also in significantly high yield. The recovery of a dilute gas component can be both economically rewarding but also be useful when the dilute component to be recovered is a noxious or of concern to the environment.

In one embodiment of the invention, there is disclosed a method for recovering in high concentrations and high yield a gas component from a gas mixture wherein the gas component is present in the gas mixture in low concentrations comprising recovering the waste stream from a concentration unit, feeding the waste stream to a recovery unit and feeding a product gas stream from the recovery unit and a feed stream of the gas mixture to the concentration unit.

In another embodiment of the invention, there is disclosed a method for recovering a gas component in high concentrations and high yield from a gas mixture wherein the gas component is present in the gas mixture in low concentrations comprising feeding a combination of the gas mixture and a product gas stream from a recovery unit to a concentration unit and feeding the waste stream from the concentration unit to the recovery unit.

In a further embodiment of the present invention, there is disclosed a method for recovering a gas component from a gas mixture wherein the gas component is present in the gas mixture in low concentrations comprising the steps:
(a) Feeding a waste stream from a concentration unit to a recovery unit;
(b) Combining a feed of the gas mixture and a product gas stream from the recovery unit;
(c) Feeding the combination of step (b) to the concentration unit; and
(d) Recovering the gas component from the concentration unit.

As is well known in the art, an isolated PSA or VSA system generates an external product stream at the upper system pressure with a higher concentration of a gas component than that which is present in the external input stream to the system and an external waste stream at the lower system pressure that contains a lower concentration of this gas component. For the purposes of the present invention, this constitutes the simplest example of a concentration unit. N individual concentration units (where N is 2 or more) may be serially connected together such that the product stream from the (N−1)th stage provides the input stream to the Nth stage and the waste stream from the Nth stage is mixed with the product stream from the (N−2)th stage (or the external input stream when N=0) to provide the input to the (N−1)th stage. Using N stages of concentration unit in this way leads to much greater levels of concentration of the gas component in the external product stream than is possible using a single stage concentration unit.

For the purposes of this invention a concentration unit is a single or multiple stage PSA or VSA system with internal recycle, that generates an external product stream with a higher concentration of a gas component than that which is present in the external input stream to the system and an external waste stream that contains a lower concentration of this gas component.

A significant fraction of the gas component present in the external feed to the concentration unit is lost in the external waste stream from the concentration unit. If the external waste stream from the concentration unit is instead used as the external input stream to a PSA or VSA system, then the concentration of the gas component in external product stream from this unit can be increased to a level that allows it to be mixed with the external input to the concentration unit, thereby substantially increasing the overall recovery of the gas component of interest. At the same time, the waste stream from the additional PSA or VSA unit contains a lower concentration of the gas component than was originally present in the waste stream from the concentration unit.

For the purposes of this invention this constitutes the simplest example of a recovery unit used in combination with a concentration unit. In practice, the overall level of recovery can be increased by using multiple serially connected recovery units with internal recycle within the recovery unit. M individual recovery units (where M is 2 or more) may be serially connected together such that the waste stream from the Mth stage alone or if M>2 this stream in combination with the product stream from the (M−2)th stage provide the input to the (M−1)th stage and the output stream from the (M−1)th stage is mixed with the waste output of the concentration unit to provide the input stream to the Mth stage. The output stream from the Mth stage, containing the gas component recovered by the recovery unit, is mixed with the external input to the concentration unit in order to recover said gas component, Using M stages within the recovery unit in combination with a concentration unit in this way leads to much greater levels of recovery of the gas component than is possible using a single stage recovery unit in combination with a concentration unit.

For the purposes of this invention a recovery unit is a single or multiple stage PSA or VSA system with internal recycle, that recovers at an increased concentration the desired gas component from the external waste stream of a concentration unit as an external product stream that may be mixed with the external feed to the concentration unit and that generates an external waste stream that contains a lower concentration of this gas component than that present in the external waste stream from the concentration unit.

Both concentration units and recovery units can independently be either pressure swing adsorption (PSA) units or vacuum swing adsorption (VSA) units or can be combinations of both PSA and VSA units.

The gas mixture can be any gas mixture that contains a valuable component at low concentration levels. In space applications, it is valuable to recover oxygen from mixtures with nitrogen and other inert gases. Oxygen can be recovered at 90% yield and 95% purity from concentrations in the initial gas mixture that can be as low as about 1%. The gas mixture, for example, can be Ar-40 and nitrogen while the gas component to be concentrated and recovered is Ar-40. Concentration can be achieved from levels of Ar-40 of around 0.1% to levels of about 99% at 85% overall yield or better. It should be noted that the overall yield can be increased by increasing the numbers of stages in the recovery unit and product purity by increasing the numbers of stages in the concentration unit, at the expense of added complexity and capital cost. Other gases including gases that are environmentally unfriendly or detrimental to industrial processes can be concentrated and recovered by the methods of the present invention.

### BRIEF DESCRIPTION OF THE DRAWINGS

FIG. 1 is a schematic process of a typical Skarstrom cycle with one equalization.

FIG. 2 is a schematic representation of a prior VSA process comprising a single concentration stage.

FIG. 3 is a schematic representation of an alternate embodiment of a prior VSA process comprising a single concentration stage.

FIG. 4 is a schematic representation of a prior VSA process in which two concentration units are connected in series.

FIG. 5 is a schematic representation of a prior VSA process comprising a two stage serial concentration unit.

FIG. 6 is a schematic representation of a prior VSA process comprising a single concentration stage.

FIG. 7 is a schematic representation of a VSA process comprising a single stage concentration unit and a single stage recovery unit.

FIG. 8 is a schematic representation of a VSA process for concentrating oxygen from 1% feed concentration to 95% comprising a two stage serial concentration unit and a two stage serial recovery unit.

FIG. 9 is a schematic representation of a VSA process for concentrating Ar-40 from 0.1% feed concentration to 99% comprising a four stage serial concentration unit and a single stage recovery unit.

### DETAILED DESCRIPTION OF THE INVENTION

The present invention provides for a method to concentrate a dilute component of a gas mixture to a higher concentration and to recover the dilute component in higher yield.

The dilute component that can be recovered is typically valuable. For example, Ar 40 from underground sources which is usually present in gas mixtures at less than 1% concentration, oxygen at low levels of concentration to higher levels of purity as for outer space applications, or krypton and xenon that are present at very low concentrations in air.

In the practice of the present invention, while only a particular number of steps are demonstrated, more PSA or VSA steps could be employed to achieve even higher purities and/or yields of the component gas sought to be recovered. The additional steps that could be added to a PSA unit cycle for example include a high pressure rinse step, a low pressure rinse step, co current depressurization and product re-pressurization. Additional interactions can also be performed during the practice of the methods of the present invention including multiple equalizations (e.g. 2 or 3 equalizations), top to bottom equalizations and simultaneous top and bottom equalizations.

Further savings and advantages can be realized by synchronizing steps between stages. This synchronization can include equalizations that can take place between different stages; feed steps that can by synchronized to reduce the number of compressors employed; and vacuum regeneration steps can be synchronized to reduce the number of vacuum pumps used.

The adsorbent materials that may be employed in the methods of the present invention are any that may be used in PSA or VSA processes where a component gas is sought to be separated from a gas mixture. While 13× zeolite has been used in the examples, performance advantages may be realized by using other adsorbents which are better matched to the desired separations. Such advantages may also be achieved by using different adsorbents in different stages as well as by using mixtures or layers of adsorbents in particular stages. The types of adsorbents that may find use in the present invention include carbon molecular sieves, 5A zeolites, LSX zeolites, binderless, lithium, sodium, potassium and rare earth substituted zeolites. The adsorbents utilized may be in particulate form, such as pellets or beads, or high performance structured forms, such as monoliths or corrugated or stacked laminate sheets. Combinations of different adsorbent forms, different bed porosities and different bead sizes may be utilized to optimize the performance of individual PSA/VSA stages.

Flow and storage devices will also be employed such as compressors, valves, tanks and other gas flow devices. These can be employed by one of ordinary skill in the art to achieve more efficient, economical or effective separations by allowing a tuning of the various separations. Other areas that can be tuned include the mixing of gas streams which should be matched as closely in composition as makes practical and economic sense, and other properties such as temperature and pressure to reduce the number of compressors, heaters, etc. employed.

The temperature at which the adsorption step of the adsorption process is carried out depends upon a number of factors, such as the particular gases being separated, the particular adsorbent being used, and the pressure at which the adsorption is carried out. In general, the adsorption step of the process is carried out at a temperature of at least about −190° C., preferably at a temperature of at least about −20° C., and most preferably at a temperature of at least about 0° C. The upper temperature limit at which the adsorption step of the process is carried out is generally about 400° C., and the adsorption step is preferably carried out at temperatures not greater than about 70° C., and most preferably carried out at temperatures not greater than about 50° C.

The adsorption step of the process of the invention can be carried out at any of the usual and well known pressures employed for gas phase vacuum swing adsorption and pressure swing adsorption processes. Typically the minimum absolute pressure at which the adsorption step is carried out is generally about 0.7 bara (bar absolute), preferably about 0.8 bara and most preferably about 0.9 bara. The adsorption can be carried out at pressures as high as 50 bara or more, but is preferably carried out at absolute pressures, and preferably not greater than about 20 bara, and most preferably not greater than about 10 bar.

The pressure during the regeneration step is reduced to a value that is less than that used in the adsorption step, usually to an absolute pressure in the range of about 0.1 to about 5 bara, and preferably to an absolute pressure in the range of about 0.175 to about 2 bara, and most preferably to an absolute pressure in the range of about 0.2 to about 1.1 bare.

The following Examples and the related Figures exemplify the advantages of the processes of the current invention over prior art PSA processes for the recovery of low concentration components from gas mixtures

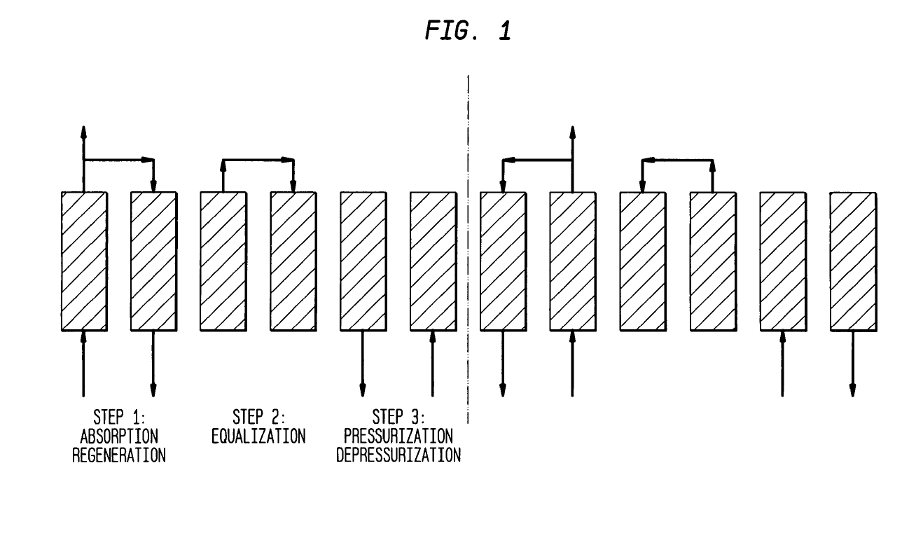

For this purpose, the Ad-nnovate dynamic adsorption simulator developed by Dr, LaCava was utilized. (Reference: “Simulation of Pressure Swing Adsorption Processes”, Doong, S. J. and A. I. LaCava, Adsorption News (Newsletter of the International Adsorption Society), February 1991, 2 (1), 4-6). High quality adsorption data for N₂, O₂, Ar, and He for the commercially available adsorbent, 13×, were used in the simulations. The Langmuir isotherm model and IAS mixing rules were used to calculate adsorbed amounts. A simple 2-bed Skarstrom cycle with a single equalization was employed. The sequence of steps used in this cycle is illustrated in FIG. 1. In these examples, each stage of each unit utilize the same VSA cycle operated between 1.2 bara to 0.3 bara with a 150 second cycle time at 298 K. For cases involving multiple integrated VSA systems solutions were found by using the combination of an equation solver with simulation of each individual VSA unit. Captions given with each figure describe in greater detail the parameters that were used in each simulation. Line numbers that are the same from drawing to drawing indicate the same functionality.

For purposes of Examples 1-3 an external feed stream comprising 1% O₂ in N₂ was employed. One goal was to obtain 95% oxygen to compress into gas cylinders.

### Comparative Example 1

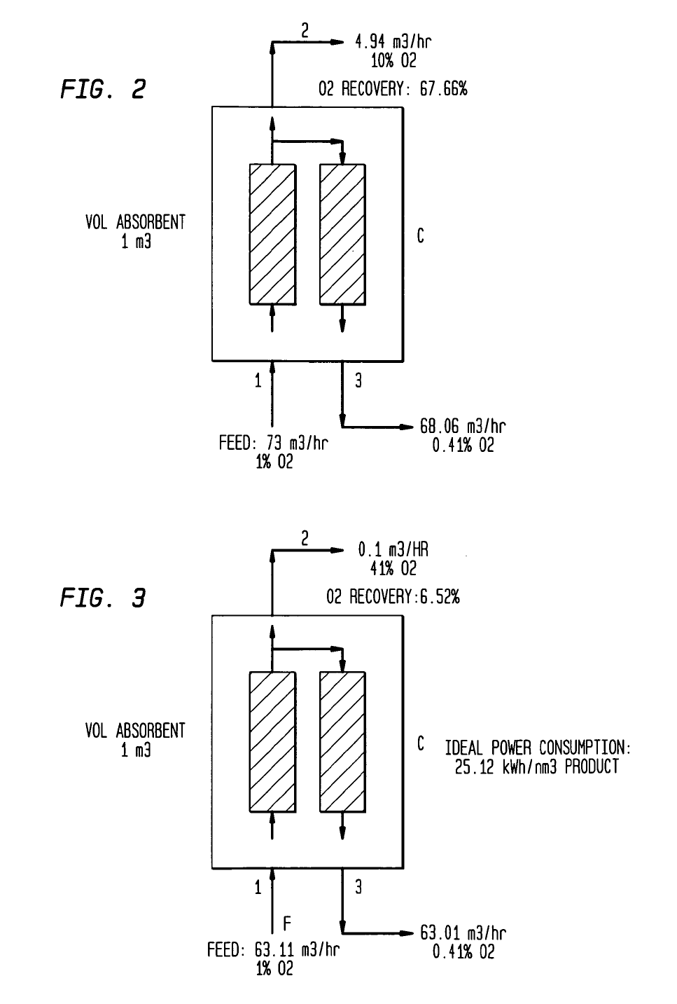

Practitioners skilled in the PSA art know that 10-fold increases in concentration of a desired component may be achieved at moderate yields in a single stage PSA or VSA cycle. FIG. 2 is a schematic of such a comparative vacuum swing adsorption cycle producing 10% oxygen from an external feed gas containing 1% oxygen utilizing a single concentration unit. The results from the simulation show that under these conditions the overall oxygen recovery would be 67.7%. In FIG. 2 diagram C represents the VSA concentration unit, line 1 the external feed, line 2 the product stream and line 3 the waste stream.

### Comparative Example 2

FIG. 3 represents another comparative example in which the output concentration from same single stage concentration unit is driven up to 41% oxygen. Diagram C represents the VSA concentration unit, line 1 the external feed, line 2 the product stream and line 3 the waste stream. The results from the simulation show that under these conditions the overall oxygen recovery is reduced 10-fold to 6.5%. It is difficult, or impossible, to increase the concentration of a dilute component to high levels of purity in a single VSA or PSA stage for these given reasonable upper and lower pressures, and not possible to achieve this at high yield.

### Comparative Example 3

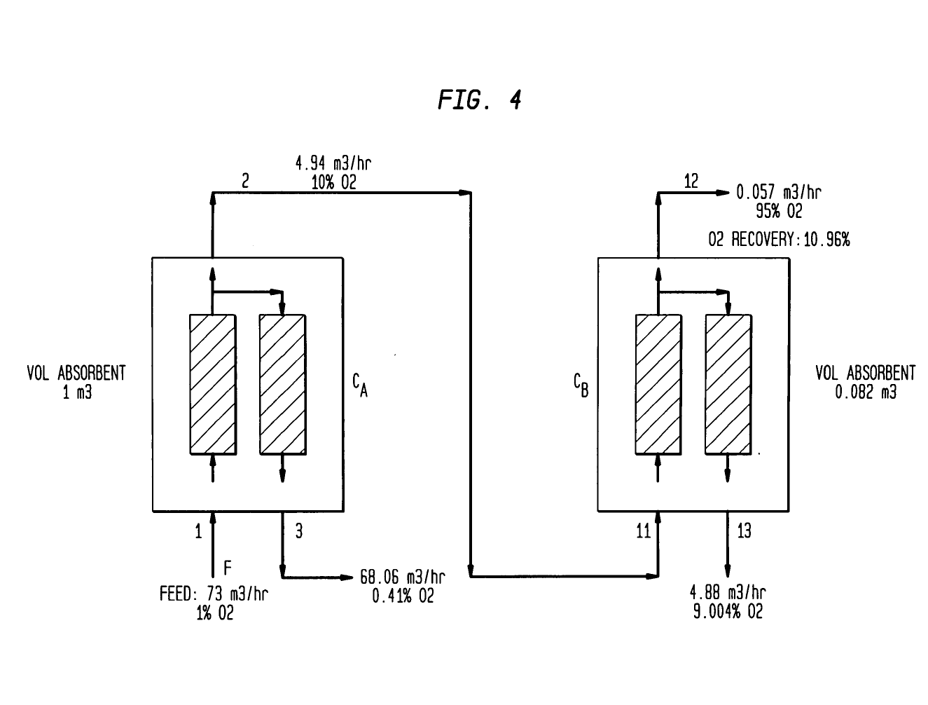

FIG. 4 depicts a comparative example in which two VSA units (depicted as units C_{A} and C_{B} in the Figure) acting as concentration stages are connected in series, i.e. the product stream (line 2) from the first unit is connected to the input of the second unit (line 11) but without recycle of the waste stream from second stage (line 13) to the input of the first stage (line 1). The input and output streams are numbered analogously to those in FIGS. 2 and 3, with lines 11, 12, and 13 in unit C_{B} corresponding in function to lines 1,2, and 3, respectively, in unit C_{A}. The results from the simulation show that it is possible to generate a product stream comprising 95% oxygen under these conditions, but that the overall oxygen recovery is only about 11%.

It is noted that the objective of achieving the desired high purity level can be achieved when using two VSA units in series but not the desired level of gas recovery.

### Comparative Example 4

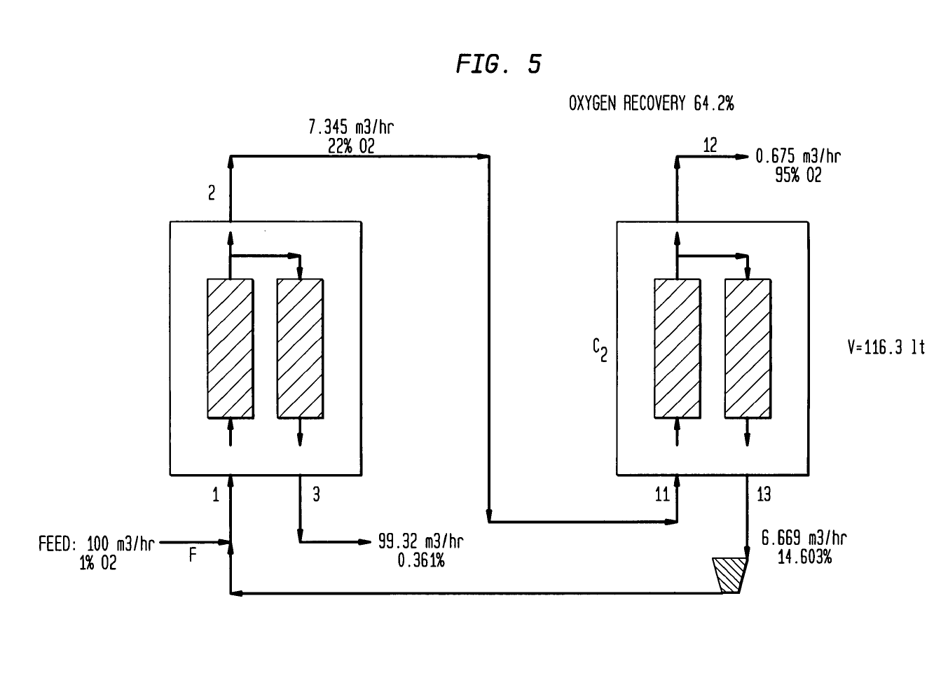

In FIG. 5, a recycle stream is added to the basic unit described in FIG. 4, that is the waste stream (line 13) from the second stage of the concentration unit (C2) is mixed with the external feed (F) to form the input stream (line 1) of the first stage of the concentration unit (C1). In the terminology of this invention this represents a two-stage concentration unit. The results of the simulation show that recycle of the waste from the second stage VSA back to the input of the first stage results in an increase in the overall oxygen recovery for the process to 64.2%.

It can be seen that properly staged multiple VSA systems offer several advantages over single concentration units. Individual plants can have widely different sizes while higher purities and higher recoveries can be obtained. There will be some need to integrate the plants, trying best to match stream compositions before mixing and more compressors will be needed to recompress the intermediate streams. The desired high yields of the desired gas component, however, at high purity can not be achieved utilizing a multiple stage concentration unit alone.

In Examples 5 and 6 an external feed stream comprising 2% O₂ in N₂ was employed to demonstrate the improvement in oxygen yield that can be obtained by the combination of a recovery unit with a concentration unit.

### Comparative Example 5

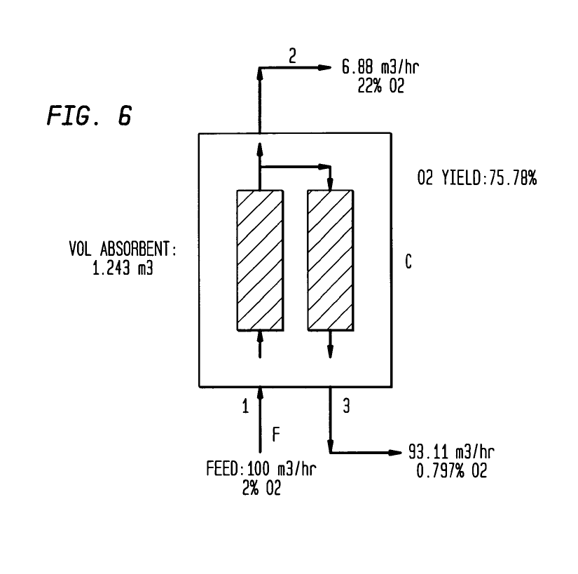

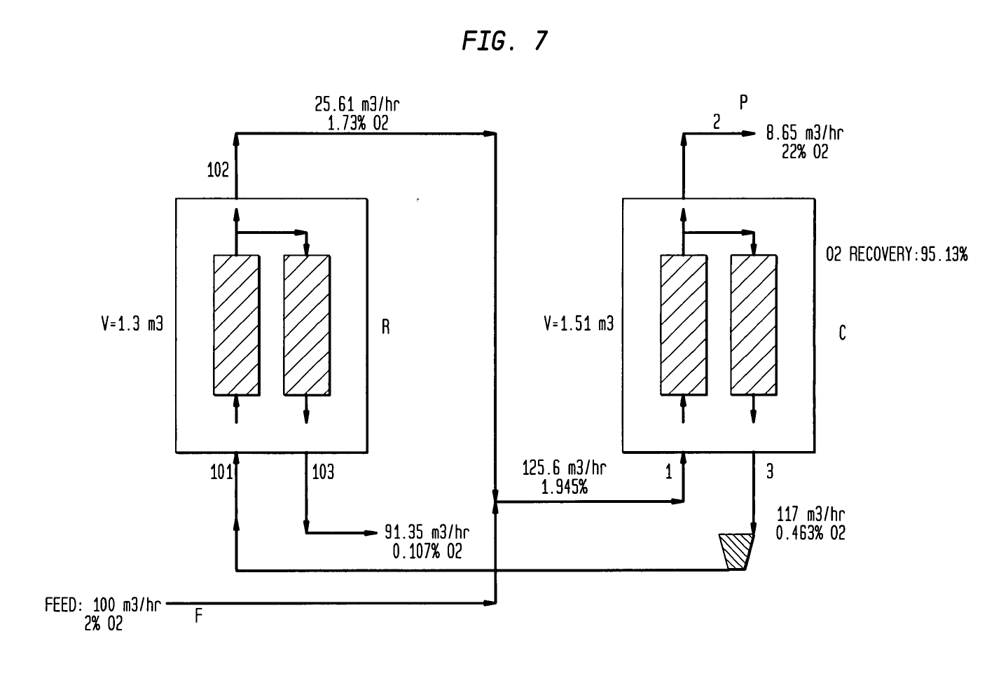

In FIG. 6, there is depicted a single VSA system acting as a concentration unit for producing oxygen at a concentration of 22%. The results of simulation show that the overall oxygen recovery under these non-demanding conditions about 76%

### Example 6

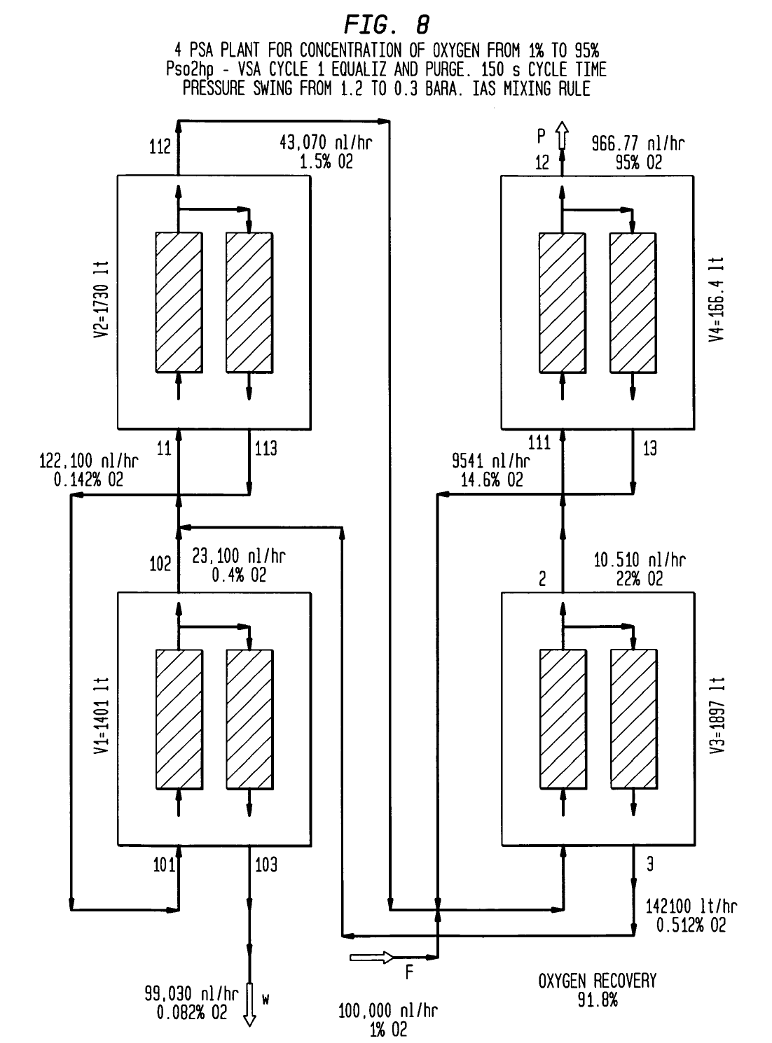

FIG. 7, shows schematically the addition of a recovery (R) unit to the system depicted in FIG. 6 with again the goal to increase the oxygen concentration of the feed from 2% to 22%. The feed, product and waste streams of the recovery unit are numbered 101, 102 and 103, respectively. The recovery VSA unit is in series with the concentration VSA unit and connected with recycle from the concentration unit. In detail, the waste stream from the concentration unit (line 3) is connected to the input of the recovery unit (line 101) and the product stream from the recovery unit (line 102) is mixed with the external feed (F) to provide the feed to the concentration unit (line 1). The results of the simulation show that the total recovered oxygen under these conditions would be 95%. This Example is for illustrative purposes demonstrating that the addition of recovery unit leads to a significant increase in the yield of the desired product. To fully achieve the targets of this invention, additional stages would be required in the concentration unit.

### Example 7

In FIG. 8, there is shown a system of the current invention, in which a two-stage VSA recovery unit (comprising recovery stages R1 and R2) is combined with two-stage VSA concentration unit (C1 and C2) with recycle of the external waste stream from the concentration unit (line 3) to the external input of the recovery unit (line 110) and connection of the external output of the recovery unit (line 112) to the external input of the concentration unit (line 1) The results of the simulation show an oxygen purity of 95% can be achieved at an overall yield of 91.8% under these conditions from a feed stream with an oxygen concentration of 1%. Comparison of the results from this Example with those from Examples 1 to 4 clearly demonstrates the advantages of the current invention over prior art PSA or VSA systems in obtaining a valuable product at high purity and high yield from a dilute mixture of this product with other gases.

### Example 8

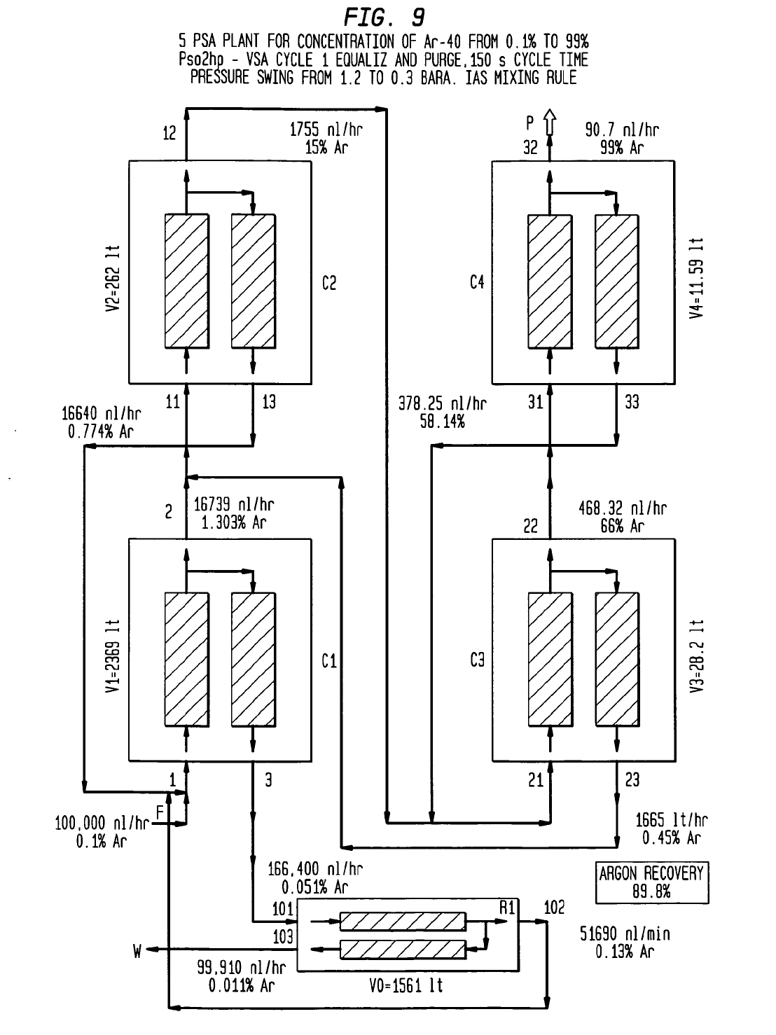

In FIG. 9, there is described a system of the current invention that utilizes a single stage VSA recovery unit (R) in combination with a 4-stage VSA concentration unit (C1-C4) in order to recover Ar-40 which is present at 0.1% level in waste gas from helium production. The lines are numbered analogously to those in the earlier Figures. The results of the simulation showed that the very valuable Ar-40 isotope could be recovered at 99% purity with an overall yield of 89% from this very dilute source.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A method for recovering in higher concentrations and higher yield a gas component from a gas mixture wherein said gas component is present in said gas mixture in low concentrations comprising recovering a waste stream from a concentration unit and feeding said waste stream to a recovery unit and feeding a product gas stream from said recovery unit and a feed stream of said gas mixture to said concentration unit.

2. The method as claimed in claim 1 wherein said high concentrations are about 70 to 100%.

3. The method as claimed in claim 1 wherein said high concentrations are about 90 to 99.9%.

4. The method as claimed in claim 1 wherein said high yield are about 80 to 99%.

5. The method as claimed in claim 1 wherein said high yield are about 85 to 97%.

6. The method as claimed in claim 1 wherein at least one stage in said recovery unit and said concentration unit are pressure swing adsorption systems.

7. The method as claimed in claim 1 wherein at least one stage in said recovery unit and said concentration unit are vacuum swing adsorption systems.

8. The method as claimed in claim 1 wherein said recovery unit is selected from the group of pressure swing adsorption systems, vacuum swing adsorption systems, and combinations of pressure swing adsorption systems and vacuum swing adsorption systems.

9. The method as claimed in claim 1 wherein said concentration unit is selected from the group of pressure swing adsorption systems, vacuum swing adsorption systems, and combinations of pressure swing adsorption systems and vacuum swing adsorption systems.

10. The method as claimed in claim 1 wherein said recovery unit and said concentration unit are a combination of pressure swing adsorption and vacuum swing adsorption systems.

11. The method as claimed in claim 1 wherein the concentration unit comprises two or more stages with recycle.

12. The method as claimed in claim 1 wherein the recovery unit comprises two or more stages with recycle.

13. The method as claimed in claim 1 wherein said low concentration is about 10% or less.

14. The method as claimed in claim 1 wherein gas mixture is selected from the group consisting of oxygen and nitrogen, Ar-40 and helium and rare-gases in air

15. A method for recovering a gas component in high concentrations and high yield from a gas mixture wherein said gas component is present in said gas mixture in low concentrations comprising feeding a combination of said gas mixture and a product gas stream from a recovery unit to a concentration unit and feeding the waste stream from said concentration unit to said recovery unit.

16. The method as claimed in claim 15 wherein said high concentrations are about 70 to 100%.

17. The method as claimed in claim 15 wherein said high concentrations are about 90 to 99.9%.

18. The method as claimed in claim 15 wherein said high yield are about 80 to 99%.

19. The method as claimed in claim 15 wherein said high yield are about 85 to 97%.

20. The method as claimed in claim 15 wherein said recovery unit and said concentration unit are pressure swing adsorption systems.

21. The method as claimed in claim 15 wherein said recovery unit and said concentration unit are vacuum swing adsorption systems.

22. The method as claimed in claim 15 wherein said recovery unit is selected from the group of pressure swing adsorption systems, vacuum swing adsorption systems, and combinations of pressure swing adsorption systems and vacuum swing adsorption systems.

23. The method as claimed in claim 15 wherein said concentration unit is selected from the group of pressure swing adsorption systems, vacuum swing adsorption systems, and combinations of pressure swing adsorption systems and vacuum swing adsorption systems.

24. The method as claimed in claim 15 wherein said recovery unit and said concentration unit are a combination of pressure swing adsorption and vacuum swing adsorption systems.

25. The method as claimed in claim 15 wherein two or more concentration units are present.

26. The method as claimed in claim 15 wherein two or more recovery units are present.

27. The method as claimed in claim 15 wherein said low concentration is about 10% or less.

28. The method as claimed in claim 15 wherein gas mixture is selected from the group consisting of oxygen and nitrogen and Ar-40 and helium.

29. The method as claimed in claim 15 wherein said waste gas stream contains some of said gas component

30. The method as claimed in claim 15 wherein said product gas stream contains some of said gas component.

31. The method as claimed in claim 15 wherein the concentration of said waste gas stream and said product gas stream in said gas component is less than said gas component present in said gas mixture.

32. A method for recovering a gas component from a gas mixture wherein said gas component is present in said gas mixture in low concentrations comprising the steps:
Feeding a waste stream from a concentration unit to a recovery unit;
b) Combining a feed of said gas mixture and a product gas stream from said recovery unit;
c) Feeding the combination of step (b) to said concentration unit; and
d) Recovering said gas component from said concentration unit.

33. The method as claimed in claim 32 wherein said recovery unit and said concentration unit are pressure swing adsorption systems.

34. The method as claimed in claim 32 wherein said recovery unit and said concentration unit are vacuum swing adsorption systems.

35. The method as claimed in claim 32 wherein said recovery unit is selected from the group of pressure swing adsorption systems, vacuum swing adsorption systems, and combinations of pressure swing adsorption systems and vacuum swing adsorption systems.

36. The method as claimed in claim 32 wherein said concentration unit is selected from the group of pressure swing adsorption systems, vacuum swing adsorption systems, and combinations of pressure swing adsorption systems and vacuum swing adsorption systems.

37. The method as claimed in claim 32 wherein two or more concentration units are present.

38. The method as claimed in claim 32 wherein two or more recovery units are present.

39. The method as claimed in claim 32 wherein said low concentration is about 10% or less.

40. The method as claimed in claim 32 wherein gas mixture is selected from the group consisting of oxygen and nitrogen and Ar-40 and helium.

41. The method as claimed in claim 32 wherein said waste gas stream contains some of said gas component

42. The method as claimed in claim 32 wherein said product gas stream contains some of said gas component.

43. The method as claimed in claim 32 wherein the concentration of said waste gas stream and said product gas stream in said gas component is less than said gas component present in said gas mixture.
